(19) United States
(12) Patent Application Publication
(10) Pub. No.: US 2009/0196311 A1
(43) Pub. Date: Aug. 6, 2009

(54) INITIATION AND EXPIRATION OF OBJECTS IN A KNOWLEDGE BASED FRAMEWORK FOR A MULTI-MASTER SYNCHRONIZATION ENVIRONMENT

(75) Inventor: Moe Khosravy, Bellevue, WA (US)

Correspondence Address: TUROCY & WATSON, LLP, 127 Public Square, 57th Floor, Key Tower, CLEVELAND, OH, 44114, US

(73) Assignee: Microsoft Corporation, Redmond, WA (US)

(21) Appl. No.: 12/023,843

(22) Filed: Jan. 31, 2008

(51) Int. Cl. H04J 3/06

(52) U.S. Cl. 370/503

(57) ABSTRACT

The subject disclosure relates to synchronizing among network nodes in a multi-master synchronization environment where a knowledge based synchronization framework is extended to include notions of initiation and/or expiration of synchronized object(s). Advantageously, according to the synchronization framework, endpoints can synchronize data in a way that allows a definition of when one or more objects of the synchronized data should come into existence for purposes of a knowledge exchange and/or when one or more objects of the synchronized data should cease to exist for purposes of a knowledge exchange. In one embodiment, additional dimension(s) are placed on a knowledge vector for a given object that represent incremental lifetime information for the object, which is accounted for during the synchronization process to allow operations on the object by synchronizing applications or processes during its lifetime.

### TECHNICAL FIELD

The subject disclosure relates to initiation and/or expiration of synchronized object(s) in a knowledge based synchronization framework for a multi-master synchronization environment.

### BACKGROUND

The popularity of mobile computing and communications devices has created a corresponding wish for the ability to deliver and receive information whenever wanted by users. Put simply, users want ubiquitous access to information and applications from a variety of devices, wherever, whenever, and whatever the devices' capabilities, and in addition, users want to be able to access and update such information on the fly, and they want guarantees that the data is as correct and up to date as can be.

There are a variety of distributed data systems that have attempted to have devices and objects share replicas of data with one another. For instance, music sharing systems may synchronize music between a PC, a Cell phone, a gaming console and an MP3 player. Email data may be synchronized among a work server, a client PC, and a portable email device. However, today, to the extent such devices synchronize a set of common information with each other, the synchronization takes place according to a static setup among the devices. However, when these devices become disconnected frequently or intermittently, i.e., when they are loosely coupled such that they may become disconnected from communicating with each other, e.g., when a cell phone is in a tunnel, or when the number of devices to be synchronized is dynamic, it becomes desirable to have a topology independent way for the devices to determine what changes each other device needs when they re-connect to one another, or as they join the network.

As shown in FIG. 1, there are various examples today where a master node 100 synchronizes in a dedicated manner with a client node 110, such as when an email server synchronizes with an email client. Due to the dedicated synchronization between the two devices, the information 102 needed to synchronize between the two devices can be tracked by the master node 100. Such information 102 can also optionally be tracked by client node 110 as well, however, when the connection between master node 100 and client node 110 becomes disconnected at times, or when the number of synchronizing devices can suddenly increase or decrease, tracking the necessary information of the common information that each device needs across all of those devices becomes a difficult problem.

Current solutions often base their synchronization semantics solely on clocks or logical watermarks for a specific node (e.g., the email server), as opposed to any node. These systems can work well in cases of a single connecting node or master. However, they run into problems when the topology or pattern in which the nodes connect can change unpredictably.

Other systems build proprietary synchronization models for specific kinds of data objects, tracking an enormous amount of primitive metadata specific to the data format across the devices in order to handle the problem. For instance, to synchronize objects of a particular Word processing document format, a lot of overhead and complexity goes into representing a document and its fundamental primitives as they change over time, and representing that information efficiently to other devices wishing to synchronize according to a common set of Word processing documents. In addition to such systems being expensive and complex to build and non-extendible due to the custom data format upon which they are based, such systems are inherently unscalable due to large amounts of metadata that must be generated, analyzed and tracked.

In addition, such solutions apply only to the one specific domain, e.g., Word processing documents. When synchronization objects of all kinds are considered, e.g., pictures, videos, emails, documents, database stores, etc., one can see that implementing custom synchronization solutions based on each object type for tracking evolution of such objects across all devices in a multi-master environment is unworkable today. Accordingly, such solutions inextricably link synchronization semantics with the data semantics.

Thus, there is a need for node-independent synchronization knowledge when computers in a topology change the way they connect to each other or as the number of computers grows. For instance, with a media player, it might be desirable to synchronize among multiple computers and multiple websites. In most instances, most applications can only synchronize data between a few well-known endpoints (home PC and media player). As the device community evolves over time for a user of the media player application, however, the need for data synchronization flexibility for the music library utilized by the devices increases, thereby creating the need for a more robust system.

The need becomes even more complex when one considers that the vast majority of computing objects are in some sense ephemeral, i.e., of use for a limited lifetime. The ability to represent when to bring an object into and out of existence in a knowledge exchange in a complex multi-master network topology of devices would thus be desirable for a myriad of synchronization scenarios. In addition to enabling an enriched set of synchronization scenarios, being able to represent and combine information about, and control, the lifetime of an object in a multi-master synchronization environment would enable a more intelligent and efficient representation of objects across all nodes by initiating objects when they become relevant, or removing objects when they are no longer relevant.

In this regard, conventional systems have only performed “deletion” operations only as part of a custom process operating on a specific identifiable set of objects, such as an email data store. For instance, as part of a retention policy, an application, such as an email program, can specifically implement custom code that by default deletes all email older than 6 months, except those email objects flagged for saving. However, such custom code operates as part of a static workflow and policy across all objects in the domain managed by the application, which is not very flexible. As a result, changing the way objects are deleted requires changing the workflow of the application.

Thus, what is desired is a way to specify when objects are to be removed from the knowledge of the device, or an application of the device. Similarly, it would be desirable to specify when objects are to be incorporated into the knowledge of the device, or an application of the device. In other words, it would be desirable to incorporate the general notions of initiation and destruction of objects into the synchronization metadata that describes the objects itself, so that the notion of initiation and destruction can be interpreted independently of which device acquires knowledge of an object. It would thus be desirable to instantiate/initiate and destruct objects as part of the overall synchronization model, so that initiation and destruction of objects can be applied on a per object basis, and independently of which node stores the object, as part of a multi-master synchronization experience.

The above-described deficiencies of today's synchronization models are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Various embodiments provide synchronization among a plurality of network nodes in a multi-master synchronization environment are described herein that extend a knowledge based synchronization framework to include notions of initiation and/or expiration of synchronized object(s). Advantageously, according to the synchronization framework, endpoints can synchronize data in a way that allows a definition of when one or more objects of the synchronized data should come into existence for purposes of a knowledge exchange and/or when one or more objects of the synchronized data should cease to exist for purposes of a knowledge exchange. In one embodiment, additional dimension(s) are placed on a knowledge vector for a given object that represent incremental lifetime information for the object, which is accounted for during the synchronization process to allow operations on the object by synchronizing applications or processes during its lifetime.

These and other embodiments are described in more detail below.

### BRIEF DESCRIPTION OF THE DRAWINGS

Various non-limiting embodiments are further described with reference to the accompanying drawings in which:

FIG. 1 illustrates a dedicated synchronization system that provides synchronization between two well defined endpoints of the system;

FIG. 2 illustrates a high level block diagram of an infrastructure for multi-master synchronization that incorporates synchronization metadata including lifetime information for synchronized objects;

FIG. 3 is a flow diagram illustrating an exemplary, non-limiting process for synchronizing based on lifetime synchronization metadata in the presence of nodes that connect and disconnect from a network;

FIG. 4 is another flow diagram illustrating an exemplary, non-limiting process for synchronizing based on lifetime synchronization metadata;

FIG. 5 illustrates exemplary non-limiting knowledge exchange between four nodes of a loosely connected network of nodes;

FIG. 6 illustrates exemplary non-limiting knowledge exchange between four nodes of a loosely connected network of nodes when some of the devices become disconnected from one another;

FIGS. 7, 8 and 9 illustrate exemplary knowledge exchange in the context of multiple objects shared among nodes of a network;

FIG. 10 is an exemplary non-limiting flow diagram illustrating the process for knowledge exchange in the context of multiple objects shared among nodes of a network;

FIG. 11 is a general architecture illustrating the framework for requesting and conveying changes based on knowledge;

FIGS. 12 and 13 are general flow diagrams illustrating initiation and expiration of synchronizing objects, respectively;

FIG. 14 illustrates state transitions for an object according to a synchronization life cycle in the knowledge based synchronization framework;

FIG. 15 is a flow diagram illustrating the progression of an object from not initiated to initiated to expired in accordance with various embodiments described herein;

FIG. 16 is a block diagram of an exemplary non-limiting implementation of a device for performing a knowledge exchange with another node via a common set of APIs;

FIG. 17 is a block diagram representing exemplary non-limiting networked environments in which various embodiments described herein can be implemented; and

FIG. 18 is a block diagram representing an exemplary non-limiting computing system or operating environment in which one or more aspects of various embodiments described herein can be implemented.

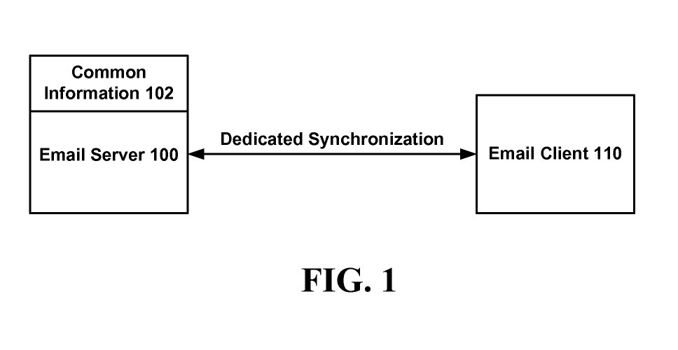

### DETAILED DESCRIPTION

### Overview

As discussed in the background, among other things, conventional systems perform deletion of objects only as part of an external workflow implementing one or more deletion policies across all data. As a result, flexibility exists only to the extent built in for different objects in advance, and one can see that as the number of classes of objects, and different policies proliferate, such a deletion process can become extraordinarily complex. Thus, what is desired is a way to incorporate the notions of initiation of objects and removal of objects into the language of synchronization itself, so that “when to instantiate an object” and “when to delete an object” are defined as part of synchronization knowledge, which efficiently represents synchronization metadata for the object, and can be used for synchronization in a multi-master synchronization environment.

Accordingly, in various non-limiting embodiments, an efficient representation of synchronization metadata is provided for multi-master synchronization of data among devices that describes when to initiate an object to start its lifetime and/or when to delete the object to end its lifetime. In contrast to conventional systems that require a specific initiation or destruction policy that is applied as part of an application workflow across all objects within the domain of the application, the initiation and deletion notions are incorporated as part of the knowledge framework that describes synchronization metadata for objects, e.g., object identifiers, versions, etc.

In this respect, the vast majority of computing objects are in some sense ephemeral. Thus, the ability to represent when to bring an object into and out of existence in a knowledge exchange in a complex multi-master network topology of devices enables a myriad of synchronization scenarios, including, but not limited to, digital rights management (DRM) for expiration of rights to an object, scheduling applied for objects, such as delaying the instantiation of calendar objects, and so on.

Any time an application can benefit from something other than a perpetual view over data, and can further benefit from being freed from the management of initiation and deletion of objects by moving the intelligence into the synchronization metadata held for the objects, the various embodiments described herein can be applied effectively. Being able to represent and combine information in synchronization knowledge about the lifetime of an object in a multi-master synchronization environment is thus advantageous for a variety of scenarios where objects can be of a limited lifetime.

As a roadmap for what follows, first, an overview of some of the embodiments described herein is presented. Then, some supplemental context is given for a general mechanism for efficiently representing knowledge in multi-master data synchronization systems. Next, exemplary, non-limiting embodiments and features are discussed in more detail for supplemental context and understanding of such multi-master data synchronization systems, followed by representative network and computing environments in which such embodiments can be implemented.

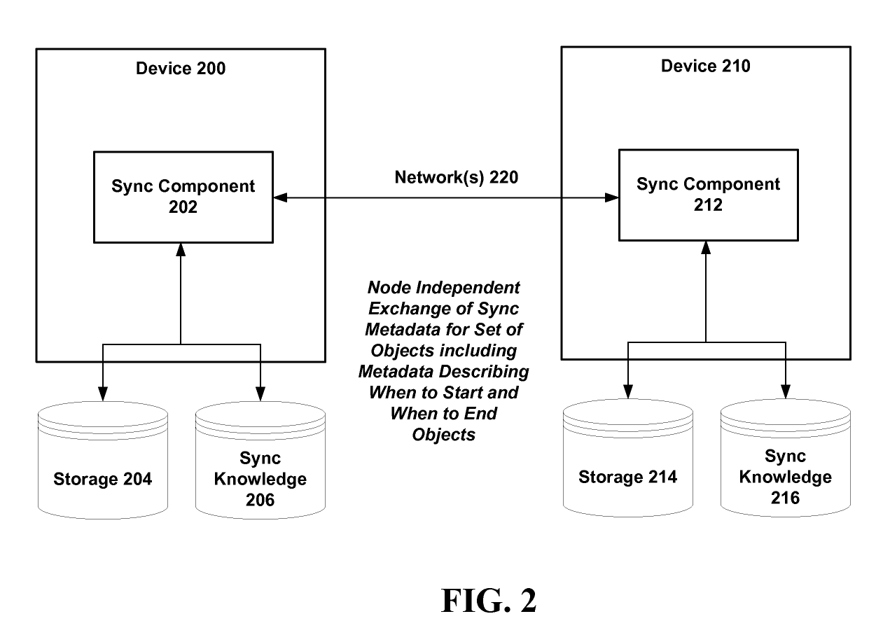

FIG. 2 is a block diagram generally illustrating the concept of objects that synchronize in a multi-master synchronization environment where the objects are initiated or destructed according to synchronization metadata defined for the objects. As shown, a device 200 and a device 210 are shown synchronizing, having connected to one another via network(s) 220, via synchronization components 202, 212, respectively. Each sync component 202, 212 stores objects in storage 204, 214 as well as maintains synchronization knowledge 206, 216, respectively, of those objects as described in more detail below. In this regard, the synchronization knowledge 206, 216 used for synchronizing independent of data type and network topology can be augmented to include metadata describing when to start and when to end objects.

In the case of metadata describing the start of an object, this can mean that the object will be created at some time in the future, and then participate in synchronization of objects, or this can mean that the object is created, or has already been created, and that the object will not yet participate in synchronization until it is started. In the case of metadata describing the end of an object, this can mean that the object ceases to participate in synchronization where implicated in a set of objects being synchronized, or this can mean that the object and any metadata about the object is deleted, or that the object can be deleted, but not the metadata describing the object.

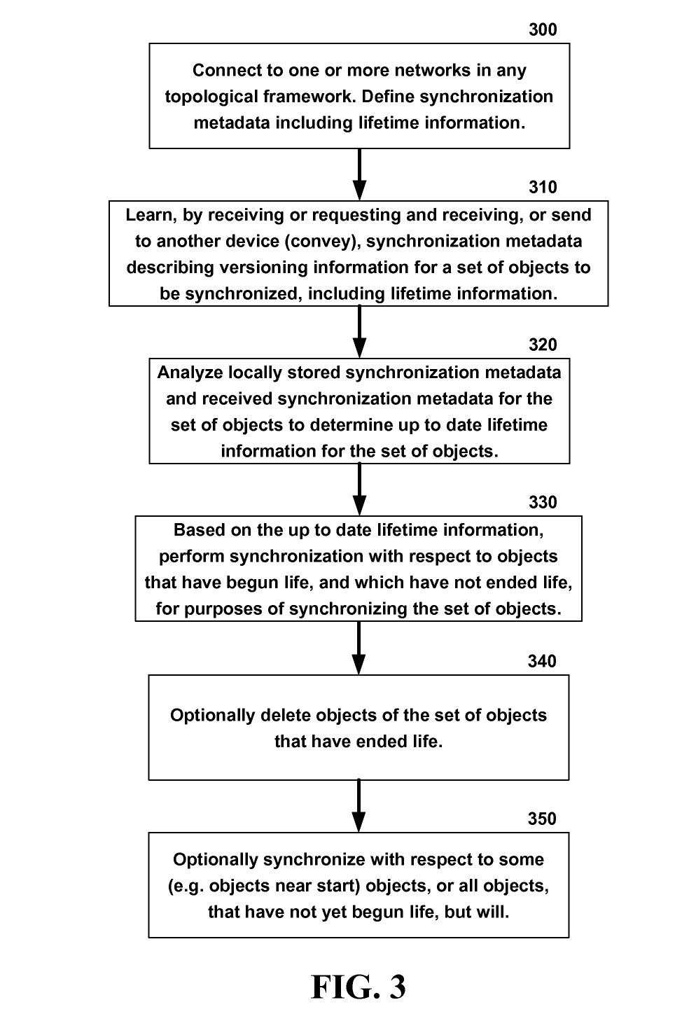

FIG. 3 is a general flow diagram describing the “start” or “end” of objects as “lifetime” information for an object for purposes of synchronizing in a multi-master synchronization environment among various nodes. At 300, at some point, synchronization metadata is defined for objects to have a limited lifetime, and a node connects to other node via one or more networks arranged according to any network topology in a multi-master synchronization environment. At 310, the node can learn synchronization metadata, i.e., by receiving, or requesting and receiving from another node, or the node can send synchronization metadata to another node where the metadata describes versioning information for the set of objects to be synchronized and includes lifetime information including information about the start and/or termination of the objects.

At 320, the synchronization metadata of the two nodes is compared to determine collective knowledge of lifetime information for the objects. At 330, optionally, based on the collective knowledge of lifetime information for the set of objects, the objects that have begun, but not ended, life are synchronized. At 340, objects that have ended life can be deleted. At 350, optionally, some objects that have not started can be synchronized anyway, e.g., to ready video data for display on another node where it can be predicted the other node will soon need the video data.

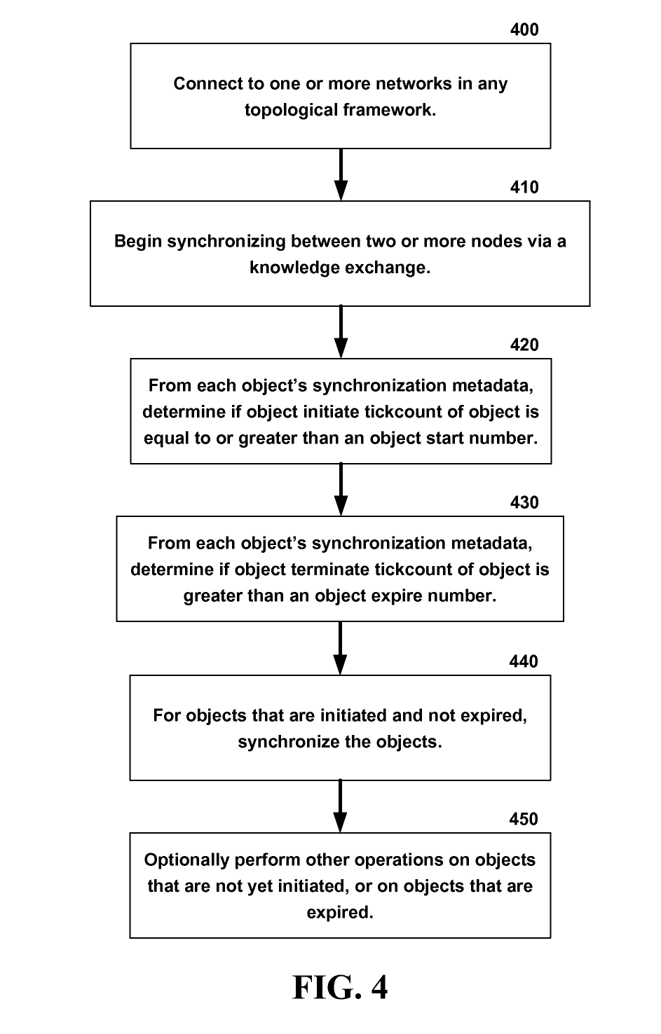

FIG. 4 is a flow chart illustration showing a representative implementation of the lifetime information as synchronization metadata in a knowledge framework for synchronizing in a multi-master environment. At 400, a node connects to other node via one or more networks arranged according to any network topology in a multi-master synchronization environment. At 410, synchronizing begins according to a knowledge exchange described in more detail below.

At 420, from each object's metadata, a synchronization component of the node determines if an object initiate tickcount of the object represented in the metadata is equal to or greater than an object start number. If so, the object has been initiated and will be synchronized. At 430, similarly, from each object's metadata, a synchronization component of the node determines if an object terminate tickcount of the object represented in the metadata is equal to or greater than an object expire number. If so, the object is expired and will be synchronized as part of a knowledge exchange. This is reflected at 440 where objects that are initiated and not expired are synchronized. Optionally, at 450, other operations can be performed on objects that are not yet initiated (e.g., sync anyway), or on objects that are expired (e.g., delete the object).

### Efficient Knowledge Representation and Exchange

As a prelude to describing the initiation and deletion of objects via synchronization metadata represented as knowledge in a multi-master synchronization environment in accordance with various non-limiting embodiments, in this section, an overview is presented of a general mechanism for efficiently representing knowledge in data synchronization systems.

The general mechanism includes (1) an efficient exchange of knowledge between connected devices by requiring only the minimum data needed by a first node from a second node to be sent, (2) the ability to efficiently and correctly recognize disagreements over the state of data, i.e., conflicts, between a first node and a second node, (3) the ability to synchronize an arbitrary number of nodes and (4) the ability to synchronize any node via any other node, i.e., the ability to work in a peer to peer, multi-master synchronization environment.

With the general mechanism, any number of changes can be made to some information that is to be shared between the two devices. At any time they become connected, by exchanging their knowledge with one another, they become aware of at least the minimum amount of information needed to reconstruct what each other knows and does not know to facilitate of changes between the devices. It is noted that where more than two devices are involved, knowledge may be incomplete knowledge of a greater base of information to be shared, but as more knowledge is shared around the multiple devices, collective knowledge continues to be accrued by the devices as they connect to the other devices over time.

Advantageously, in various non-limiting embodiments, synchronization is performed for a set of devices, or a subset of devices, all interested in maintaining the latest versions of a set of objects, but also allows such devices to come into connection and out of connection with the other objects of the set. Whenever a device comes back into connection with other device(s) of the set of devices via one or more networks, the device regains collective knowledge that is as up to date as the other device(s) represent with their collective knowledge. In this fashion, even loosely connected devices may come into and out of contact with a set of devices, and then relearn all the knowledge missed by coming into contact with any set of devices that possess the latest set of collective knowledge.

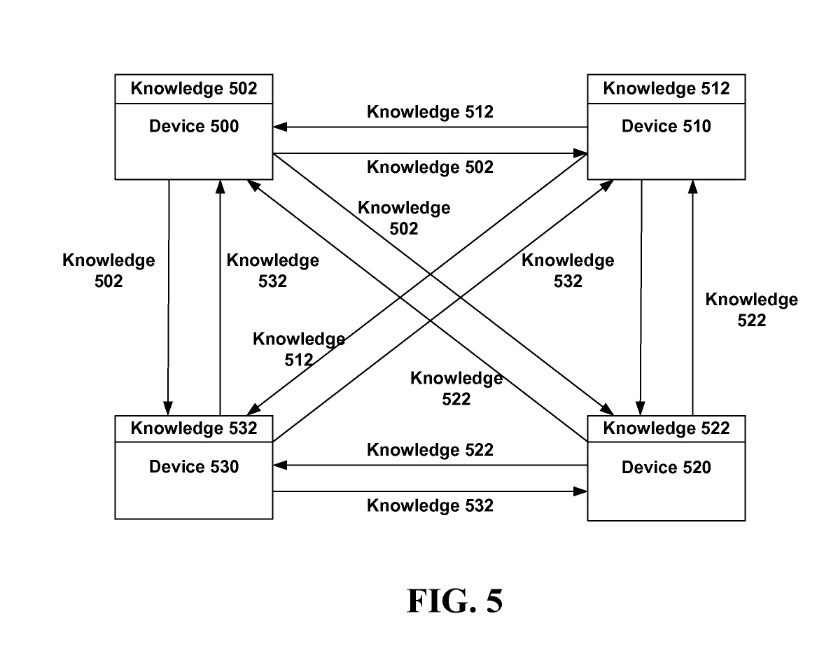

FIG. 5 illustrates that knowledge exchanges are generalizable, or scalable, to any number of devices. As shown, four devices 500, 510, 520 and 530 are shown with knowledge representations 502, 512, 522 and 532 that respectively indicate what each device knows and doesn't know about a set of common information to be shared across the devices.

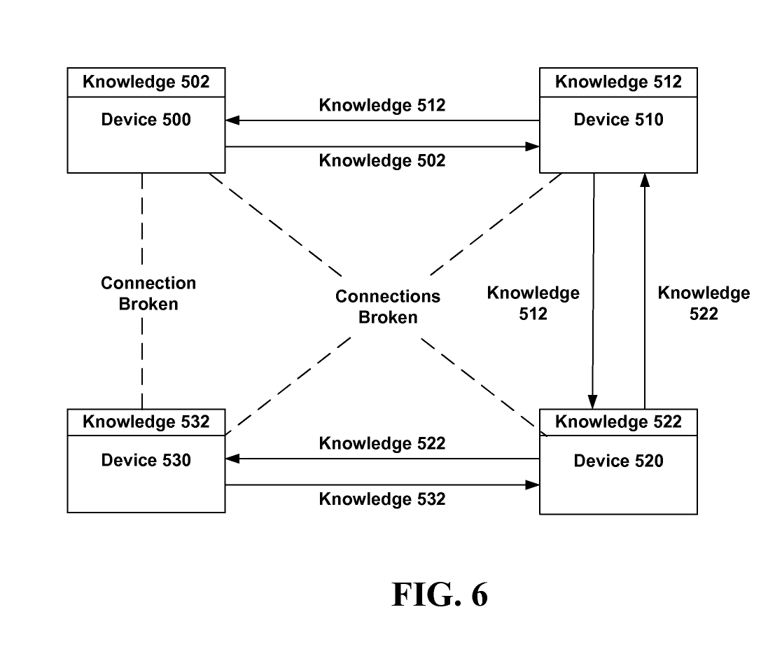

Advantageously, as shown by FIG. 6, even where connections in the network become disconnected, a complete set of knowledge can nonetheless be gained by all of the devices 500, 510, 520, and 530, as long as at least one connection directly or indirectly exists to the other devices. For instance, as shown, knowledge 532 of device 530 still reaches device 500 via the knowledge exchange with device 520, then via the knowledge exchange between device 520 and 510, and finally via the knowledge exchange between device 510 and 500.

With more devices sharing knowledge about common information to be shared, all of the devices benefit because knowledge exchange(s) in accordance with various non-limiting embodiments are agnostic about from which device collective knowledge comes. The devices each independently operate to try to gain as much knowledge about information to be shared among the devices from any of the other devices to which it is connected.

In exemplary non-limiting detail, a method is described in further detail for two nodes to engage in a conversation and at the end of the conversation to have equivalent knowledge for the concerned data set. The method is scalable beyond two nodes by creating a knowledge exchange capability for each new device entering the peer-to-peer network/multi-master environment.

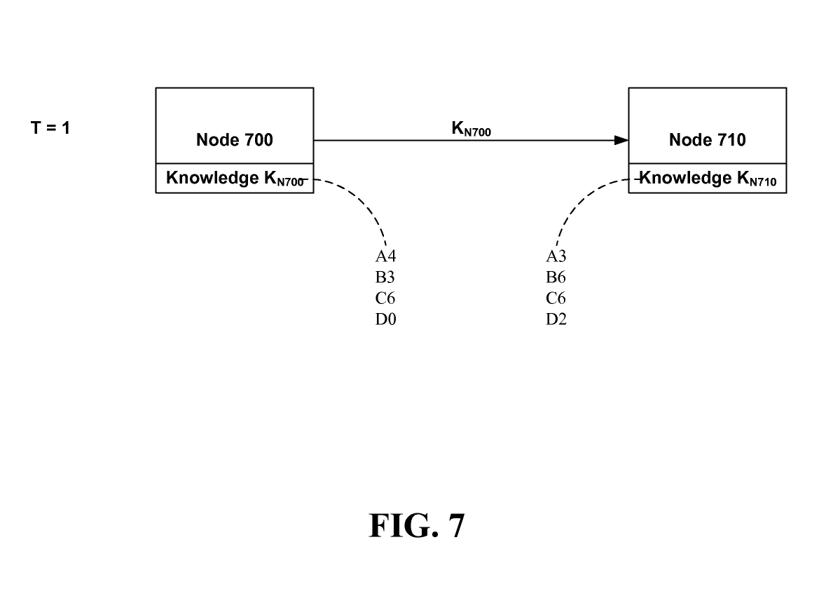

Thus, as shown in FIG. 7, node 700 of a peer-to-peer network having any number of nodes wants to exchange data with Node 710. Node A begins by requesting changes from Node 710 and in order to do so Node 700 sends its knowledge (represented as K_{N700}) to Node 710 as shown.

Knowledge of a device or node is represented by labeling each object to be shared among devices with a letter identifier, and then the trailing number represents the latest version for this object. For instance, K_{N700} as shown in FIG. 7 includes objects A, B, C and D each to be synchronized between nodes 700 and 710, and the number following each of the objects represents the latest version of the object known on the device. For instance, knowledge K_{N700} at a time t=1 includes the 5^{th} version of A, the 4^{th} version of B, the 7^{th} version of C, and the 1^{st} version of D, notated as A4, B3, C6, D0 in FIG. 7. In contrast, knowledge K_{N710} of node 710 at a time t=1 may include the 4^{th} version of A, the 7^{th} version of B, the 7^{th} version of C, and the 3^{rd} version of D, notated as A3, B6, C6, D2 in FIG. 7.

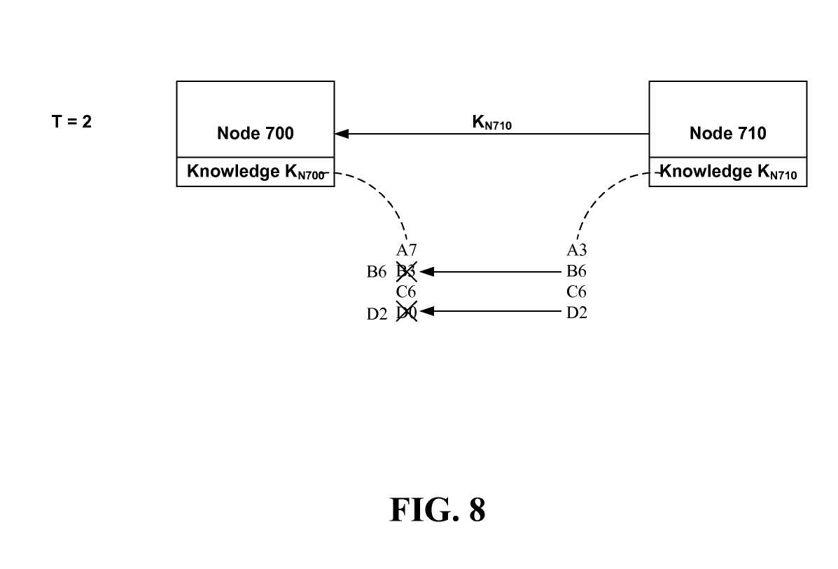

As shown in FIG. 8, at time T=2, node 710 compares knowledge K_{N700} received from node 700 against its own knowledge K_{N710} and determines what needs to be sent to node 700. In this example, as a result, node 710 will send node 700 the changes relating to B and D since node 700's knowledge of B3, D0 is behind node 710's knowledge of B6 and D2. When node 710 sends node 700 the changes between B6 and B3, and the changes between D2 and D0, it also sends along the latest version of knowledge K_{N710} it has (reflecting whenever the last change on node 710 was made).

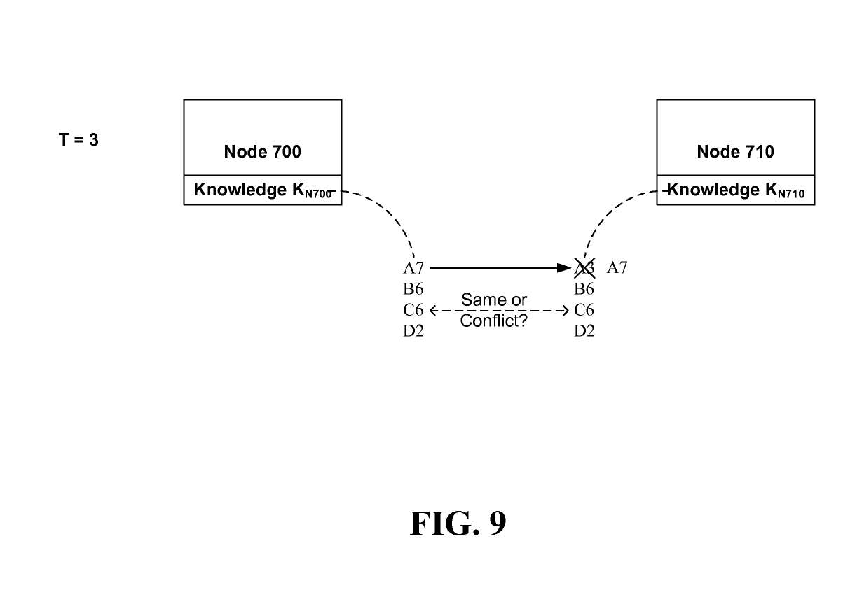

As shown in FIG. 9, representing time t=3, sending knowledge K_{N710} to node 700 allows node 700 to detect conflicts (e.g., store them for later resolution) if it later finds out that both node 700 and node 710 made a change to an object while they were on the same version. This allows for autonomous updating, efficient enumeration, but also correct conflict detection when the nodes meet and exchange changes. For instance, in the example, if C6 is not the same object in both knowledge K_{N710} and K_{N710}, e.g., if both independently evolved from C5 to C6, then which C6 is the correct C6 can be set aside for conflict resolution, e.g., according to pre-set policy resolution that befits the synchronization scenario and devices involved.

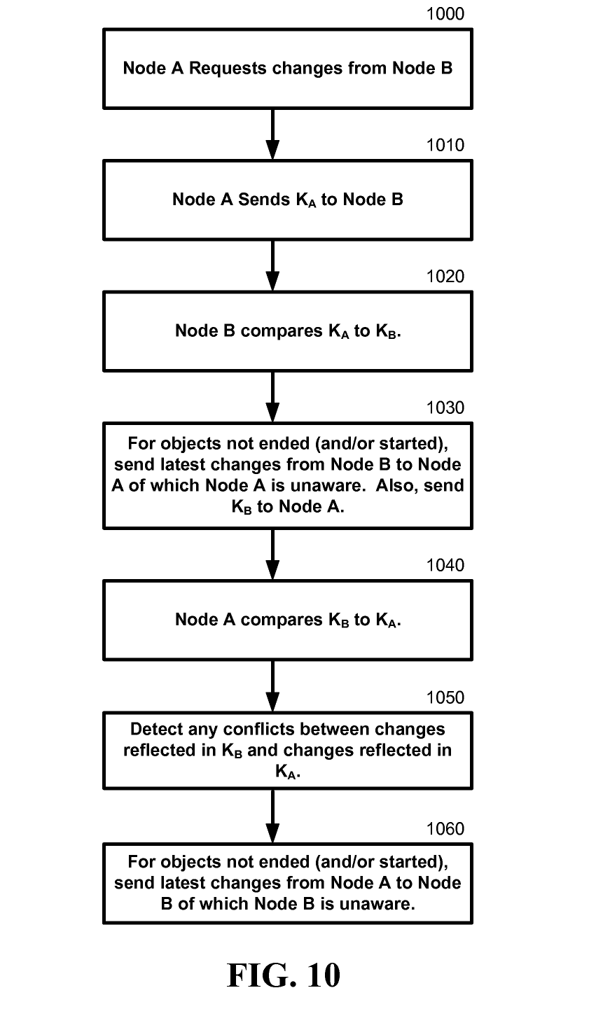

An exemplary knowledge exchange process between any two nodes of a distributed multi-master synchronization environment using the above described general mechanism is shown in the flow diagram of FIG. 10. At 1000, node A requests synchronization with node B, thereby asking node B for changes node A does not know about. In order to equip node B, at 1010, node A sends its knowledge to node B. At 1020, node B compares the knowledge received from node A with its own knowledge to determine what changes node B knows about that should be sent to node A. At 1030, node B sends such changes to node A, and in addition, node B sends its knowledge to node A so that node A can perform a similar knowledge comparison at 1040. Consistent with embodiments described herein, objects that are ended or not started according to the metadata are not synchronized.

At 1050, node A detects any potential conflicts between latest versions reflected in the knowledge of node B and latest versions reflected in the knowledge of node A, in the event that independent evolution of versions has occurred on node A and node B. Optionally, any conflict resolution policy may be applied to determine which node trumps the other node in the event of a conflict. At 1060, the latest changes from node A that are not possessed by node B are sent to node B. The conflict resolution policy will additionally dictate whether any changes are sent from node B to node A, or node A to node B, to maintain common information between the nodes. If independent versioning is OK, or desirable, no conflict resolution is another option. Consistent with embodiments described herein, objects that are ended or not started according to the metadata are not synchronized.

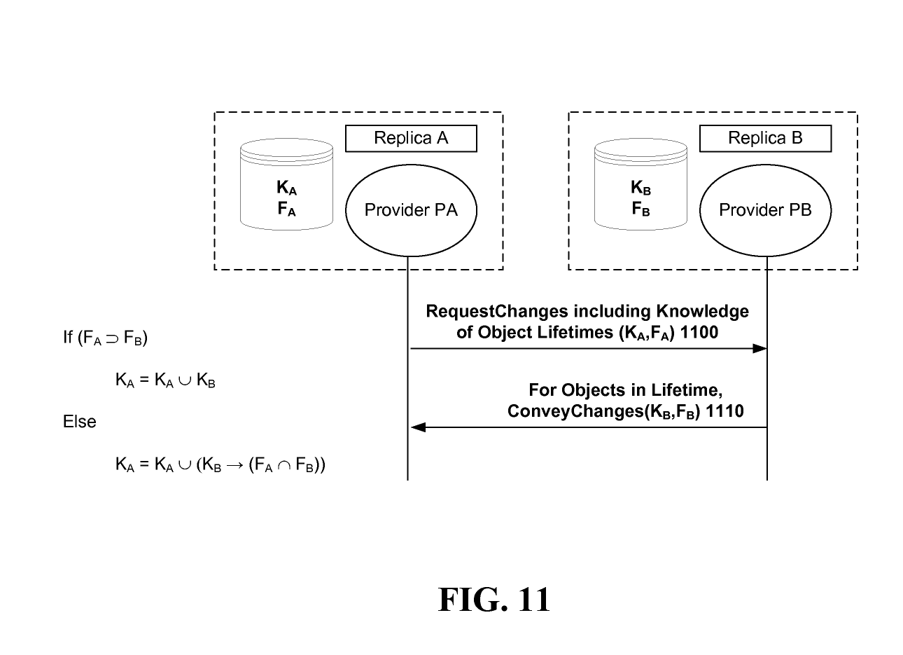

FIG. 11 illustrates the generalized mechanism for exchanging knowledge when filtered knowledge is possible, i.e., where a subset of a node's knowledge is to be synchronized with one or more of the other nodes. As shown, each replica A and B has a synchronization provider PA and provider PB, respectively. In this regard, each replica A and B maintains knowledge K_{A} and K_{B}, respectively, and potentially also maintains filtered knowledge F_{A} and F_{B}. Similar to the case with no subsetting, any of the replicas can request changes 1100 of another replica and receive changes 1110 in response to the other replica conveying changes. As illustrated, replica A can request changes for a set of objects of a given scope at 1100, sending its knowledge including information about the lifetimes of the objects of the set. Similarly, at 1110, based on an analysis of the knowledge K_{A} and K_{B}, at 1110, the changes that replica B knows, but replica A does not know about, are sent to replica A for the objects that are within their lifetime. If the filtered knowledge F_{A} and filtered knowledge F_{B} are of the same scope, then as with the generalized knowledge exchange:

K_{A}=K_{A}∪K_{B}

If the filtered knowledge F_{A} and filtered knowledge F_{B} are not of the same scope, then instead the knowledge is a function of existing knowledge plus the knowledge of the other replica as projected onto the intersection of their respective Filters F_{A} and F_{B}, as follows:

K_{A}=K_{A}∪(K_{B}→(F_{A}∩F_{B}))

Among other applications, an exemplary, non-limiting application for these types of filters is for filtering columns, or any change units of a synchronization framework. This is particularly applicable since column changes are not likely to be subject to move operations in the system. There are two considerations for this scenario worth noting: filter representation and knowledge consolidation.

With respect to filter representation, filter representation for the case of no move filters is as follows. Each filter is represented as a list of the change units contained within the filter. This representation provides a convenient means of representation as well as the ability to combine filters when necessary. The ability to combine filters is useful for consolidating knowledge.

With respect to knowledge consolidation, in order to keep knowledge in its most concise form the ability to consolidate knowledge must be maintained. In this regard, fragments of filtered knowledge can be consolidated so that knowledge can be maintained in its most compact form.

Considering the ability to combine filters, since filters can be represented as a set of change units, overlaps in filters can be reconciled by isolating the sets of change units that exist in both filters.

Also, since the vector for a filter applies to each of the individual change units within the filter, the combination of the filters can be performed by finding the combined vector for the change unit for each change unit in both filters. Then once all of the vectors are known, the change units that have a common vector are recombined into a new filter.

Accordingly, the notion of knowledge can be used to efficiently represent data for knowledge exchanges among multiple nodes of a multi-master synchronization network, any node of which may independently evolve common information, or subsets of common information, to be synchronized across the nodes. The above-described knowledge based framework can be implemented for a multi-master synchronization environment and as described in more detail below, the framework is extendible to incorporate the notions of initiation and deletion of objects via efficient synchronization metadata.

Knowledge Based Initiation and/or Destruction of Objects

As mentioned, various embodiments of knowledge based initiation of objects and/or deletion of objects are provided herein by augmenting metadata included in a knowledge framework, an overview of which was provided above. For the avoidance of doubt, the term “initiation” as used herein is meant broadly, and refers to any way in which data can come to be accessible, created, stored or synchronized in a computing system. For instance, the initiation capabilities described can be applied to scenarios where it is desirable to delay the presence of an object as part of synchronization, but nonetheless specify future synchronization when certain criteria are satisfied.

Similarly, the terms “deletion” or “destruction” refers broadly to any way in which data can become removed, unreadable, or otherwise inaccessible, or not synchronized along with other objects being synchronized in a computing system. For instance, the deletion capabilities described can be applied to scenarios where it is desirable for data to expire after a predetermined number of events occur.

Various embodiments provide synchronization among a plurality of network nodes in a multi-master synchronization environment are described herein that extend a knowledge based synchronization framework to include notions of initiation and/or expiration of synchronized object(s). Advantageously, according to the synchronization framework, endpoints can synchronize data in a way that allows a definition of when one or more objects of the synchronized data should come into existence for purposes of a knowledge exchange or when one or more objects of the synchronized data should cease to exist for purposes of a knowledge exchange.

As mentioned, in one embodiment, additional dimension(s) can be placed on a knowledge vector for a given object that represent lifetime information for the object, which is accounted for during the synchronization process to allow operations on the object by synchronizing applications only during its lifetime. For instance, with respect to the start of an object, where an object is represented as O5 according to the knowledge based framework described above, indicating knowledge of the fifth version of an object O, an additional initiation item can be added to the knowledge vector, as O5I3, indicating knowledge of the fifth version of an object O, which is to be initiated after 3 initiation count ticks. With respect to the end of an object, e.g., for an object O5, an additional expiration item can be added to the knowledge vector, as O5E7, indicating knowledge of the fifth version of an object O, which is to be initiated after 7 expiration count ticks. Accordingly, based on the additional dimension(s) placed on the knowledge vector, knowledge of objects incorporates the notion of initiation and destruction of objects in a knowledge based synchronization framework.

As described above, a synchronization framework for multi-master synchronization defines a model for synchronization based on the concept of knowledge, defining the summary of the state based synchronization of a replica. In many cases it is useful to synchronize data in a way that allows an endpoint to define when one or more objects of the synchronized data should come into existence for purposes of a knowledge exchange (e.g., to synchronize an email object at a future date) or when one or more objects of the synchronized data should cease to exist for purposes of a knowledge exchange.

Either scenario can be accomplished with an additional dimension placed on the knowledge vector for a given object.

For instance, where knowledge of an object is Ix: A5 on a device, to make the object become synchronized as part of a knowledge exchange in the future, knowledge of the object can be augmented simply as Ix: A5 F4, which means that an interpreting endpoint receiving knowledge of the object from the device as part of a synchronization will not treat the object Ix: A5 as existing until the conditions pre-supposing F1, F2, and F3 have been satisfied. These conditions can be time passing according to intervals, number of hops by the object to intervening endpoints, number of times rendered, number of times modified or edited, number of times operated on by a particular application, number of occurrences of a particular external event, etc., i.e., any future function F is contemplated that would bring the object into existence for purpose of synchronizing data in the future, after counting a number of occurrences defined by the function F.

For another example, where knowledge of an object is Ix: C8, to stop the object from being synchronized as part of a knowledge exchange in the future, knowledge of the object can be simply augmented as Ix: C8 S6, which means that an interpreting endpoint receiving knowledge of the object from the device as part of a synchronization will synchronize the object data until the conditions pre-supposing S1, S2, S3, S4, S5 and S6 have been satisfied. Again, the conditions can be time passing according to intervals, number of hops by the object to intervening endpoints, number of times rendered, number of times modified or edited, number of times operated on by a particular application, number of occurrences of a particular external event, etc., i.e., any function S to which a tick count can be assigned in consideration of which it can be determined whether to sunset the object or not by an interpreting device.

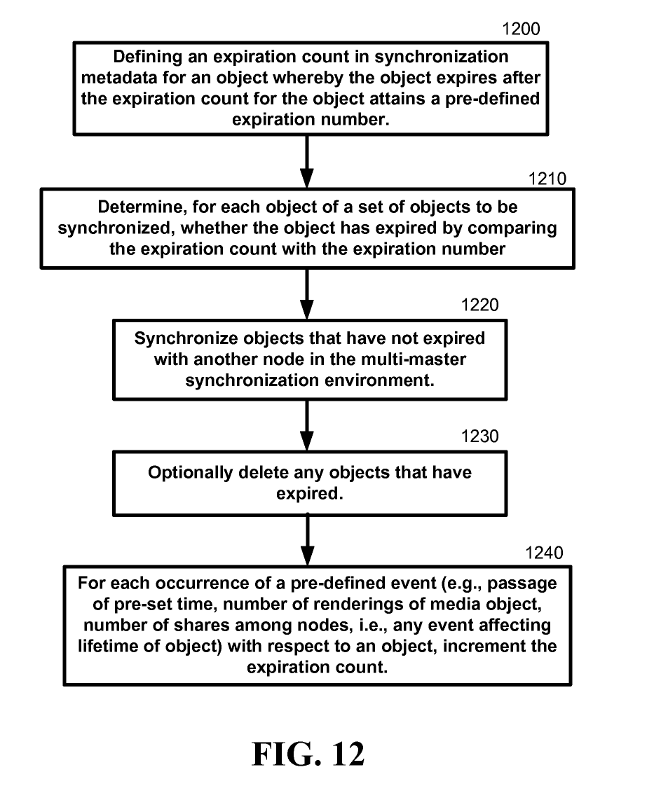

Various embodiments can include the expiration metadata for objects, or the initiation metadata for objects, or both. FIG. 12 is a flow diagram of an embodiment where expiration metadata for objects is included, but not initiation metadata. Such an approach employing expiration metadata in a knowledge exchange would be useful, for instance, as a digital rights management (DRM) implementation for content where, content expires, and ceases to synchronize among a user's device after 3 device shares to limit the amount of sharing among devices, or where it is desirable to have promotional material expire after a pre-set number of renderings. Another use for expiring data is to implement a document expiration policy for periodic deletion of data on a server, e.g., after 6 months pass from creation of the object. For the avoidance of doubt, these are non-limiting scenarios, and the number of scenarios where it is desirable to expire data as part of a synchronization experience are limitless.

In FIG. 12, at 1200, an expiration count is defined for an object in synchronization metadata maintained for the object whereby the object expires after the expiration count for the object attains an expiration number defined for the object. Then, at 1210, for purposes of synchronizing, it is determined whether each object to be synchronized has expired by comparing the expiration count of the metadata with the expiration number. The expiration count for the object increases any time a pre-defined function is satisfied (e.g., each time a month passes, or each time the object is modified, etc.). At 1220, the objects that are not expired are synchronized with other node(s) in the multi-master synchronization environment. At 1230, since there may be objects that have expired, optionally the objects can be deleted. Also, once the object is deleted, the metadata describing the object can also optionally be deleted. At 1240, i.e., between synchronizations, any number of events may occur which increment the expiration counts associated with a set of objects being synchronized. In short, as expiration counts indicate expiration, such objects no longer synchronize.

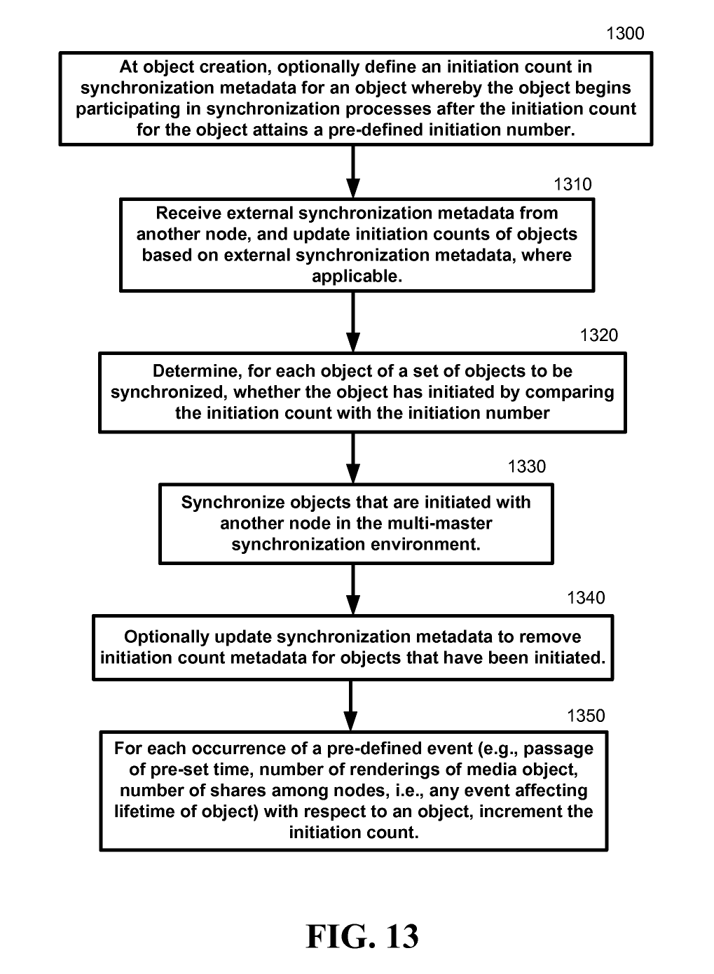

FIG. 13 is a flow diagram of an embodiment where initiation metadata for objects is included, but not expiration metadata (though as mentioned, initiation and expiration metadata can be implemented independently in a single embodiment). Such an approach employing initiation metadata in a knowledge exchange would be useful, for instance, as a digital rights management (DRM) implementation for content where, the content owner has not yet authorized the release of the content, e.g., as part of a press release, but wishes to set the wheels in motion in the future to synchronize the content of the press release. Another use for delaying the initiation of synchronization of data is to encourage the user to take certain acts before the content synchronizes, e.g., registering the user before allowing synchronization. Another use for delaying the initiation of an object is to delay a transmission to a particular time in the future, e.g., to delay transmission of an email. For the avoidance of doubt, these are non-limiting scenarios, and the number of scenarios where it is desirable to initiate data in the future as part of a synchronization experience are limitless.

In FIG. 13, at 1300, an initiation count is defined for an object in synchronization metadata maintained for the object whereby the object expires after the initiation count for the object attains an initiation number defined for the object. Then, at 1310, for purposes of synchronizing, it is determined whether each object to be synchronized is initiated by comparing the initiation count of the metadata with the initiation number. The initiation count for the object increases any time a pre-defined function is satisfied (e.g., each time a month passes, after some other object is acted on, after related objects come into existence, etc.). At 1320, the objects that are initiated are synchronized with other node(s) in the multi-master synchronization environment.

At 1330, for objects that have become initiated, since initiation metadata can be considered irrelevant at that point, optionally knowledge (sync metadata) of the objects in terms of when initiated can be deleted. Such knowledge can also be preserved. Moreover, at this junction, for an embodiment where expiration metadata is also used, the point at which an object becomes initiated is also a suitable time to define expiration metadata for the object, where desirable. In this regard, once the object is initiated, the initiation metadata describing the object can thus optionally be deleted. At 1340, i.e., between synchronizations, any number of events may occur which increment the initiation counts associated with a set of objects. In short, as initiation counts indicate initiation, such objects begin to synchronize. Such objects can be created at initiation time, or can be created beforehand, but not synchronized until initiation.

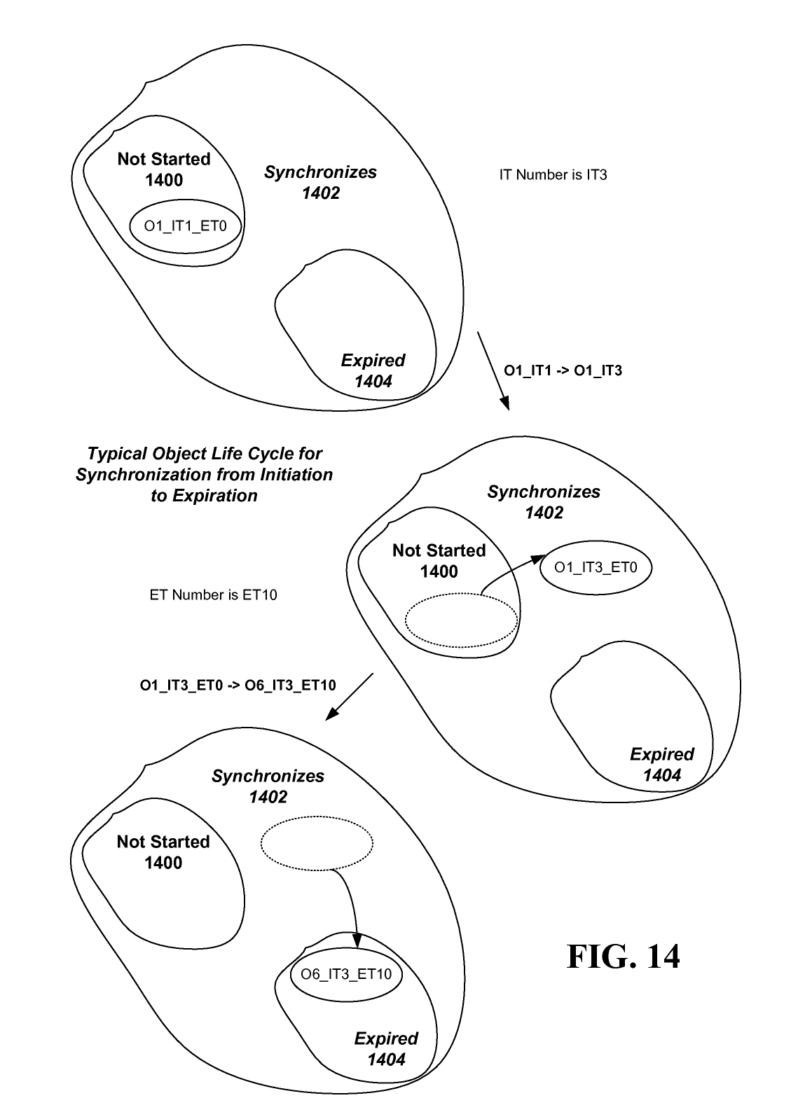

FIG. 14 sets forth these concepts in terms of a state transition diagram based on the synchronization metadata described above for initiating and terminating the synchronization of data related to objects in the system. For instance, starting in the upper left state, an object having knowledge vector O1_IT1_ET0 indicating a second version of object O, having an initiation tickcount of 1 and an expiration tickcount of 0 is illustrated in the not started state 1400 (i.e., the object does not synchronize). In the example, a synchronizing process defines an initiation target number of 3, such that when a pre-defined function is satisfied 2 more times, i.e., when the initiation tickcount associated with object O reaches 3, object O becomes initiated, and enters the synchronizes state 1402 whereby the object O synchronizes according to a typical knowledge exchange in a multi-master environment as described above.

Once initiated and synchronizing in state 1402, then the expiration tickcount can come into play. In this regard, the synchronizing process can define an expiration target number for the object, e.g., 10. After the object undergoes 10 expiration tickcount increments after a pre-defined function is satisfied 10 times (e.g., passage of 10 months, or occurrence of 10 events, such as 10 renderings or edits), the object expires and enters the expired state 1404. As shown, it may be a different version of the object that expires such as O6 after the object O1 undergoes five independent modifications. As mentioned above, in the not started state 1400, it is optional to include expiration tickcount metadata for an object and in the synchronizes state 1402 or expired state 1404, it is optional to include initiation tickcount metadata.

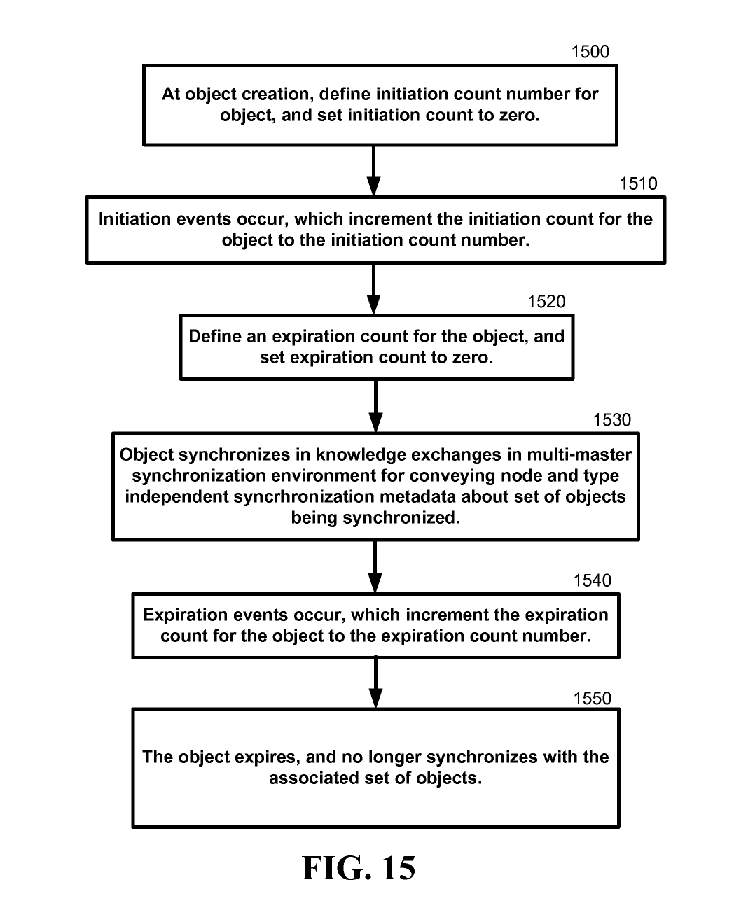

FIG. 15 illustrates the transitions for an object being synchronized through synchronization life cycle as a non-limiting flow diagram describing one implementation. At 1500, an object is created and an initiation count number can be defined for the object that determines when the object is to become live for synchronization purposes. The synchronization metadata includes an initiation count that is set to zero, ready for incrementing until the object becomes live. At 1510, as pre-defined initiation events occur, the initiation count represented in the knowledge vector for the object is incremented, until the initiation count number is reached and the object becomes live. At this stage, the object moves from not-initiated yet to initiated.

At 1520, an object is initiated and thus, an expiration count number can be defined for the object that determines when the object is to be ignored or deleted for synchronization purposes. The synchronization metadata includes an expiration count that is set to zero, ready for incrementing until the object expires. At 1530, synchronization of the initiated object takes place according to the knowledge exchange principles enumerated in FIGS. 5 to 11. At 1540, as pre-defined expiration events occur, the expiration count represented in the knowledge vector for the object is incremented, until the expiration count number is reached and the object expires at 1550. At this stage, the object moves from initiated to expired, and thus the object no longer synchronizes even where the object is within scope of a knowledge exchange request. For storage savings, expired objects can optionally be deleted.

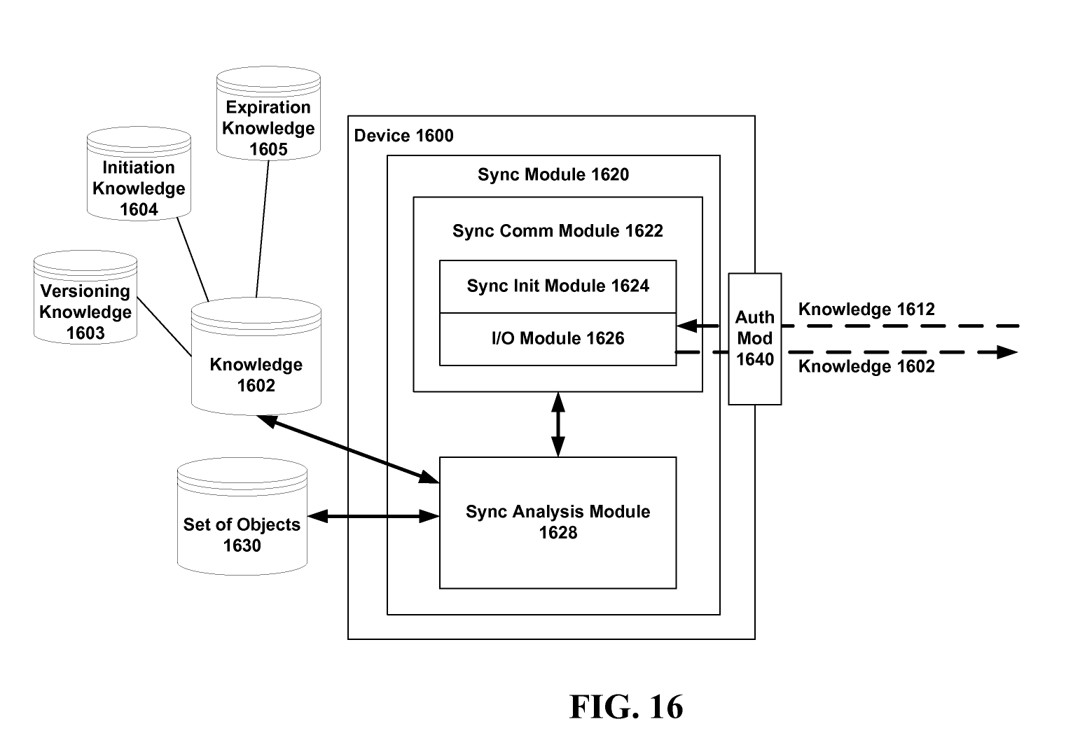

FIG. 16 is a block diagram of an exemplary non-limiting implementation of a device 1600 for performing a full or partial knowledge exchange via a set of APIs. As shown, device 1600 includes a sync module 1620 that performs knowledge exchange techniques for synchronizing a set of objects 1630 with another device in accordance with non-limiting embodiments. The set of objects 1630 can also be stored in a cache (not shown) for efficient operations, and then set of objects 1630 can be later updated by offline applications. Sync module 1620 may include a sync communications module 1622 for generally transmitting and receiving data in accordance with knowledge exchange techniques to and from other nodes as described herein.

Sync communications module 1622 may also include a sync initiation module 1624 which may initiate synchronization with a second device if authorized, e.g., via optional authorization module 1640, and connect to the second device. Sync module 1622 may also include an I/O module 1626 responsive to the initiation of synchronization by sending full and/or partial knowledge 1602 about the set of objects 1630 to a second device via APIs, e.g., for getting or sending knowledge or for getting or sending changes. Similarly, I/O module 1626 can receive requested knowledge or changes 1612 of the second device and changes to be made to the set of objects 1630 originating from the second device. In turn, a sync analysis module 1628 operates to apply any changes to be made to the set of objects 1630 and to compare knowledge 1612 received from the second device with the knowledge 1602 of the first device in order to determine changes to be made locally or to send to the second device to complete synchronization between the devices.

In accordance with embodiments herein, knowledge 1602 possessed by a node of a set of objects 1630, such as versioning knowledge 1603 as described in connection with FIGS. 5 to 11, is augmented to include initiation knowledge 1604, which defines when an object begins to synchronize in the knowledge based framework, and/or expiration knowledge 1605, which defines when an object ceases to synchronize in the knowledge based framework.

### Exemplary Networked and Distributed Environments

One of ordinary skill in the art can appreciate that the various embodiments of the synchronization infrastructure described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may use the synchronization infrastructure as described for various embodiments of the subject disclosure.

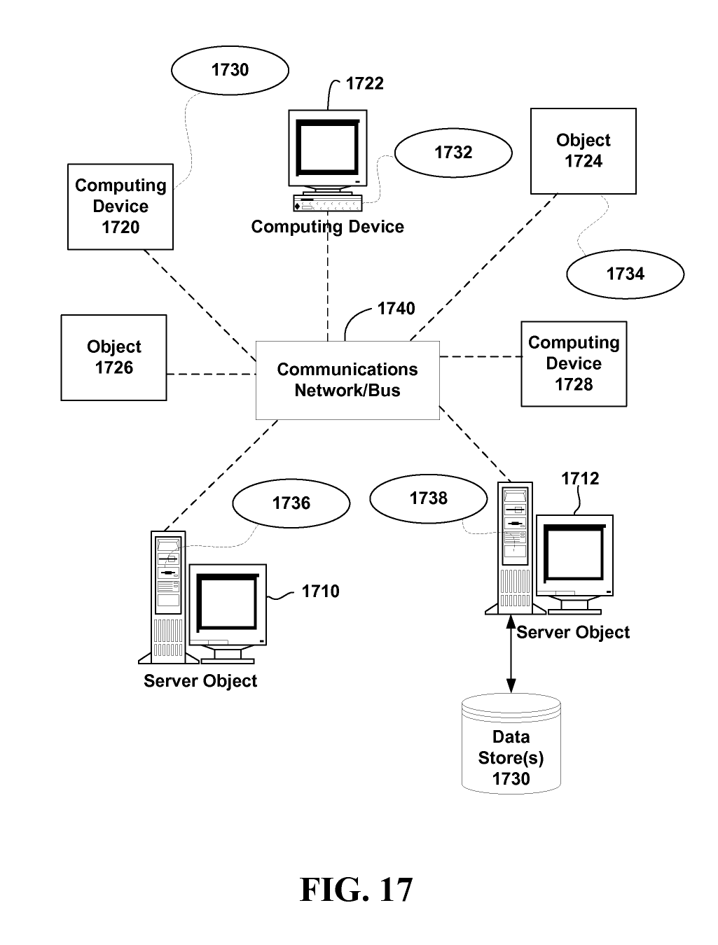

FIG. 17 provides a schematic diagram of an exemplary networked or distributed computing environment. The distributed computing environment comprises computing objects 1710, 1712, etc. and computing objects or devices 1720, 1722, 1724, 1726, 1728, etc., which may include programs, methods, data stores, programmable logic, etc., as represented by applications 1730, 1732, 1734, 1736, 1738. It can be appreciated that objects 1710, 1712, etc. and computing objects or devices 1720, 1722, 1724, 1726, 1728, etc. may comprise different devices, such as PDAs, audio/video devices, mobile phones, MP3 players, personal computers, laptops, etc.

Each object 1710, 1712, etc. and computing objects or devices 1720, 1722, 1724, 1726, 1728, etc. can communicate with one or more other objects 1710, 1712, etc. and computing objects or devices 1720, 1722, 1724, 1726, 1728, etc. by way of the communications network 1740, either directly or indirectly. Even though illustrated as a single element in FIG. 17, network 1740 may comprise other computing objects and computing devices that provide services to the system of FIG. 17, and/or may represent multiple interconnected networks, which are not shown. Each object 1710, 1712, etc. or 1720, 1722, 1724, 1726, 1728, etc. can also contain an application, such as applications 1730, 1732, 1734, 1736, 1738, that might make use of an API, or other object, software, firmware and/or hardware, suitable for communication with or implementation of the synchronization infrastructure provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the synchronization infrastructure as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 17, as a non-limiting example, computers 1720, 1722, 1724, 1726, 1728, etc. can be thought of as clients and computers 1710, 1712, etc. can be thought of as servers where servers 1710, 1712, etc. provide data services, such as receiving data from client computers 1720, 1722, 1724, 1726, 1728, etc., storing of data, processing of data, transmitting data to client computers 1720, 1722, 1724, 1726, 1728, etc., although any computer can be considered a client, a server, or both, depending on the circumstances. Any of these computing devices may be processing data, synchronizing or requesting services or tasks that may implicate the synchronization infrastructure as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the synchronization infrastructure can be provided standalone, or distributed across multiple computing devices or objects.

In a network environment in which the communications network/bus 1740 is the Internet, for example, the servers 1710, 1712, etc. can be Web servers with which the clients 1720, 1722, 1724, 1726, 1728, etc. communicate via any of a number of known protocols, such as the hypertext transfer protocol (HTTP). Servers 1710, 1712, etc. may also serve as clients 1720, 1722, 1724, 1726, 1728, etc., as may be characteristic of a distributed computing environment.

### Exemplary Computing Device

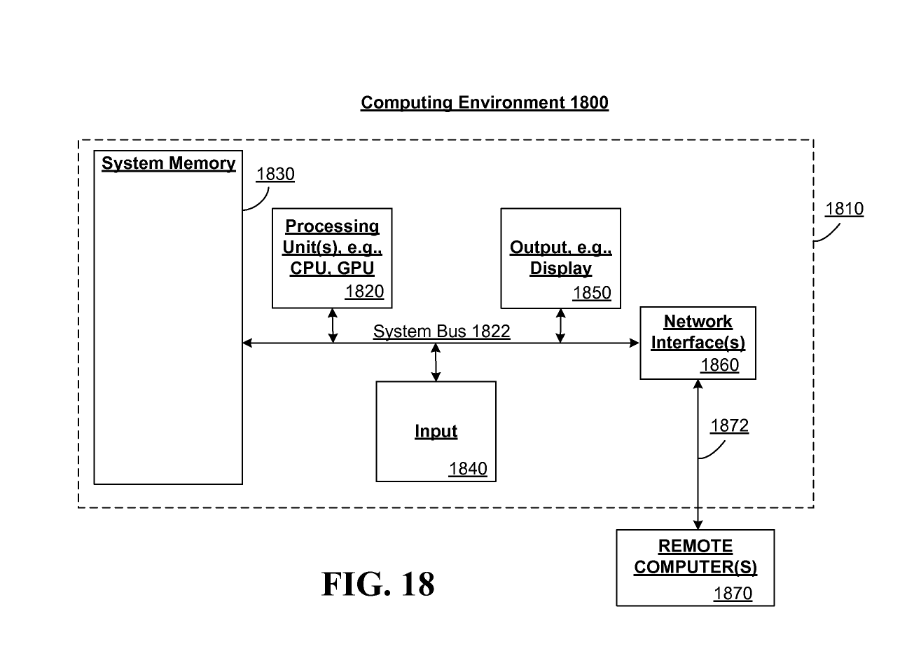

As mentioned, advantageously, the techniques described herein can be applied to any device where it is desirable to synchronize with other objects in a computing system. It should be understood, therefore, that handheld, portable and other computing devices and computing objects of all kinds are contemplated for use in connection with the various embodiments, i.e., anywhere that a device may synchronize. Accordingly, the below general purpose remote computer described below in FIG. 18 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 18 thus illustrates an example of a suitable computing system environment 1800 in which one or aspects of the embodiments described herein can be implemented, although as made clear above, the computing system environment 1800 is only one example of a suitable computing environment and is not intended to suggest any limitation as to scope of use or functionality. Neither should the computing environment 1800 be interpreted as having any dependency or requirement relating to any one or combination of components illustrated in the exemplary operating environment 1800.

With reference to FIG. 18, an exemplary remote device for implementing one or more embodiments includes a general purpose computing device in the form of a computer 1810. Components of computer 1810 may include, but are not limited to, a processing unit 1820, a system memory 1830, and a system bus 1822 that couples various system components including the system memory to the processing unit 1820.

Computer 1810 typically includes a variety of computer readable media and can be any available media that can be accessed by computer 1810. The system memory 1830 may include computer storage media in the form of volatile and/or nonvolatile memory such as read only memory (ROM) and/or random access memory (RAM). By way of example, and not limitation, memory 1830 may also include an operating system, application programs, other program modules, and program data.

A user can enter commands and information into the computer 1810 through input devices 1840. A monitor or other type of display device is also connected to the system bus 1822 via an interface, such as output interface 1850. In addition to a monitor, computers can also include other peripheral output devices such as speakers and a printer, which may be connected through output interface 1850.

The computer 1810 may operate in a networked or distributed environment using logical connections to one or more other remote computers, such as remote computer 1870. The remote computer 1870 may be a personal computer, a server, a router, a network PC, a peer device or other common network node, or any other remote media consumption or transmission device, and may include any or all of the elements described above relative to the computer 1810. The logical connections depicted in FIG. 18 include a network 1872, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to synchronize.

Also, there are multiple ways to implement the same or similar functionality, e.g., an appropriate API, tool kit, driver code, operating system, control, standalone or downloadable software object, etc. which enables applications and services to use the synchronization infrastructure. Thus, embodiments herein are contemplated from the standpoint of an API (or other software object), as well as from a software or hardware object that provides synchronization capabilities. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The term “limited lifetime” shall refer to a restriction on existence of an object in a synchronizing system such that the start and/or end of existence of the object is restricted.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment or set of embodiments, but rather should be construed in breadth, spirit and scope in accordance with the appended claims.

What is claimed is:

1. A method for synchronizing a set of objects between a first node and a second node of a plurality of nodes communicatively coupled via one or more networks in a multi-master synchronization environment, comprising:
defining by the first node at least one object of the set of objects to have a limited lifetime and updating synchronization knowledge metadata of the first node concerning the set of objects represented on the first node to include lifetime metadata indicating the limited lifetime of the at least one object, wherein representation of the synchronization knowledge metadata is independent of data type; and
synchronizing by the first node with the second node, the synchronizing including transmitting, by the first node to the second node, the updated synchronization knowledge metadata of the first node including transmitting corresponding version metadata for the objects of the set of objects representing versions of the set of objects represented on the first node and any corresponding lifetime metadata for the objects.

2. The method of claim 1, wherein the defining includes defining an expiration number for the at least one object whereby the at least one object expires after the expiration number of pre-defined events occur, the lifetime metadata including the predetermined number.

3. The method of claim 1, wherein the defining includes defining an initiation number for the at least one object whereby the at least one object does not join the set of objects for purposes of operating on the at least one object by a synchronizing application or service until the initiation number of pre-defined events occur, the lifetime metadata including the initiation number.

4. The method of claim 1, further comprising:
analyzing, by the first node, the synchronization knowledge metadata, and determining at least one object having corresponding lifetime metadata that indicates expiration of the at least one object; and
deleting, by the first node, the at least one object and updating the synchronization knowledge metadata to remove any knowledge of the at least one object.

5. The method of claim 1, further comprising:
analyzing, by the first node, the synchronization knowledge metadata, and determining at least one object having corresponding lifetime metadata that indicates initiation of the at least one object; and
updating the synchronization knowledge metadata to reflect that the at least one object is initiated as part of the set of objects.

6. The method of claim 5, wherein the updating includes deleting the lifetime metadata representing the initiation of the at least one object from the synchronization knowledge metadata.

7. A method for synchronizing a set of objects between a second node and a first node of a plurality of nodes communicatively coupled via one or more networks in a multi-master synchronization environment, comprising:
receiving external synchronization knowledge, by the first node from the second node, concerning the set of objects represented on the second node, the synchronization knowledge including a data scope for the set of objects, corresponding versions for the objects of the set of objects represented on the second node and corresponding expiration information for at least one of the objects of the set of objects, wherein representation of the synchronization knowledge is independent of data type;
comparing local synchronization knowledge of the first node concerning the set of objects represented on the first node with the external synchronization knowledge of the second node; and
determining if the expiration information for an object of the at least one of the objects indicates expiration of the object.

8. The method of claim 7, further comprising:
if the expiration information for the object indicates expiration, updating the local synchronization knowledge to remove the object from the set of objects represented on the first node within the data scope.

9. The method of claim 8, wherein the updating the local synchronization knowledge to remove the object further includes deleting the object from the first node.

10. The method of claim 8, wherein the updating the local synchronization knowledge to remove the object further includes deleting any synchronization metadata concerning the object from the local synchronization knowledge.

11. The method of claim 7, further comprising:
determining changes to the external knowledge of the set of objects represented on the second node and corresponding changes to the set of objects represented on the second node based on the comparing step; and
transmitting the changes to the external knowledge and the corresponding changes to the set of objects to the second node.

12. The method of claim 7, wherein the determining includes determining by the first node if a function of a number represented by the expiration information for the object has been satisfied.

13. The method of claim 7, wherein the determining includes determining by the first node if a number of pre-defined operations on the object have been performed.

14. The method of claim 7, wherein the determining includes determining by the first node if a number of pre-defined time periods have passed relative to a start time for the object.

15. The method of claim 7, wherein the determining includes determining by the first node if a number of pre-defined events external to the object have been performed.

16. A node of a plurality of nodes connectable via one or more networks that synchronizes a set of objects between the node and another node of the plurality of nodes in a multi-master synchronization environment, comprising:
a synchronization component for synchronizing the set of objects between the node and the other node of the plurality of nodes, including:
a synchronization communications component that initiates synchronization with the other node via a synchronization protocol that defines, independent of data type, metadata structure for a knowledge exchange between the other node and the node, that transmits to the other node a request to synchronize with the set of objects based on the synchronization protocol and that receives external knowledge of the set of objects from the other node in response including other node object versioning information corresponding to the set of objects represented on the other node and other node object initiation information corresponding to at least one object of the set of objects represented on the other node indicating when the at least one object initiates in the multi-master synchronization environment for purposes of synchronizing; and
a synchronization analysis component that updates local knowledge of the set of objects represented on the node and corresponding node object versioning information by comparing the external knowledge of the set of objects, corresponding other node object versioning information and corresponding other node object initiation information with the local knowledge of the set of objects, corresponding node object versioning information and corresponding node object initiation information to determine what changes should be reflected by updated local knowledge of the set of objects, corresponding node object versioning information and corresponding node object initiation information.

17. The node of claim 16, wherein, for each object of the set of objects represented by the updated local knowledge having corresponding node object initiation information, the synchronization analysis component determines whether a function of a number specified in the node object initiation information is satisfied for the object.

18. The node of claim 17, wherein, if the function is not satisfied for the object, the synchronization analysis component prevents processes of the multi-master synchronization environment pertaining to the set of objects to access the object.

19. The node of claim 16, wherein the synchronization analysis component analyzes the external knowledge of the set of objects, corresponding other object versioning information and corresponding other object initiation information with the local knowledge of the set of objects, corresponding node object versioning information and corresponding node object initiation information to determine what changes should be sent to the other node about which the other node does not know.

20. The node of claim 16, wherein the synchronization protocol does not prescribe any schema of the actual data being synchronized between the node and the other node.
